(19) United States
(12) Patent Application Publication
(10) Pub. No.: US 2014/0280859 A1
(43) Pub. Date: Sep. 18, 2014

(54) SHARING CONTROL SYSTEM AND METHOD FOR NETWORK RESOURCES DOWNLOAD INFORMATION

(71) Applicant: Tencent Technology (Shenzhen) Company Limited, Shenzhen Guangdong (CN)

(72) Inventors: Gang Liu, Shenzhen Guangdong (CN); Xiaokang Li, Shenzhen Guangdong (CN); Yan Huang, Shenzhen Guangdong (CN)

(21) Appl. No.: 14/352,798

(22) PCT Filed: Sep. 20, 2012
(86) PCT No.: PCT/CN2012/081642

§ 371 Date: Apr. 18, 2014

(30) Foreign Application Priority Data
Oct. 26, 2011 (CN) 201110329358.5

(51) Int. Cl. H04L 12/24; H04L 29/06

(52) U.S. Cl. CPC H04L 41/00; H04L 63/10
USPC 709/223

(57) ABSTRACT

A system and method to control sharing network resources download information may include a microblog sharing interface server, a sharing resources database, and a transfer server. A network resource may be received and a corresponding unique identifier may be obtained by the microblog sharing interface server. A download link entry address may be generated and posted to a microblog. The unique identifier of the network resource may be stored in the sharing resources database. The transfer server allow downloading the network resource based on corresponding download control conditions obtained from the sharing resources database using the unique identifier in the download link entry address. The source download link address of the network resource may be obtained based on the unique identifier if downloading is allowed and the source download link address sent to the client. Thus risks associated with transmission of the network resource download information may be effectively controlled.

This application is the US national phase of International Application No. PCT/CN2012/081642, filed on Sep. 20, 2012, which claims priority to Chinese Patent Application No. 201110329358.5, filed on Oct. 26, 2011, entitled “SHARING CONTROL SYSTEM AND METHOD FOR NETWORK RESOURCES DOWNLOAD INFORMATION”, which are incorporated herein by reference in their entireties.

### FIELD OF THE INVENTION

The present invention relates to the field of network data communication technology, and in particular to a sharing control system and method for network resource download information.

### BACKGROUND OF THE INVENTION

Network resources are generally referred to as digital resources. Such resources may be stored in the network and are provided to a user for download and use. The resources may include program files, video files, audio files and other such digital content. The network resources may be downloaded via Peer to Server (P2S), Peer to Peer (P2P), or a combination of such technologies.

In case of Peer to Server (P2S) technology, the network resources may be stored in servers of a large-scale downloading website, and users may directly download the resource files from the downloading website. Speed of the download way may be ensured, but resources may be dispersed and may not be easy to be searched.

In case of Peer to Peer (P2P) technology, also referred to as an equipotent technology, a device used by the user downloading the resources may affect the download. The P2P technology depends on computing capacity and bandwidth of the device of a network resource download participant, rather than only on the several servers. The P2P technology is widely applied in sharing a file and downloading a file. In P2P technology, downloading speed of one terminal may be closely related to uploading speed of another terminal Users may access the resource files via a network connection with low uploading speed, such as ADSL which may support only dozens of Kbps. Some users may purposely restrict the uploading speed. There may be other factors resulting in lack of uploading bandwidth resources. Therefore, users usually feel that speed of P2P technology is low.

In case of Peer to Server and Peer (P2SP) technology, unlike the conventional way, the downloading may not depend only on the server, rather the content may be spread among the various terminal machines in the network. Besides the P2P, the P2SP may further include a server (indicated by the “S” in the P2SP). The P2SP may effectively integrate isolated servers, mirror resources of the servers, of the P2S technology, and P2P resources together. Compared to conventional P2P or P2S technology, downloading stability and downloading speed of the P2SP technology may be greatly improved. The P2SP technology may be based on user to server mechanism and user to user mechanism, and is different from the P2P technology and the P2S technology. The P2SP technology may support P2P technology, and may further integrate server resources and P2P resources together through a searching database. The P2SP may search resources automatically and select a suitable resource for accelerating a file download. Therefore, the downloading stability and the downloading speed of the P2SP may be greatly improved compared to conventional P2P technology.

In P2SP technology, when a network resource file is downloaded, data sources may include a source download link, a P2P network, an auxiliary source of a third party mirror, and any other such data sources. An integrity of the file may be protected by a unique identifier, such as a unique identifier acquired by calculating according to Message Digest Algorithm Version 5 (MD5) or Secure Hash Algorithm (SHA). FIG. 1 illustrates a particular control flow chart of sharing and downloading of a network resource in an example P2SP technology. Referring to FIG. 1, P2SP may include a downloading client, a resource index server, a Tracker server, and a statistics server.

The downloading client may be used for periodically reporting an online condition and/or information of a resource to the Tracker server. The downloading client may also be used for inquiring a resource index server via source URL, for a multi-resource URL collection, a HASH value file check information, and/or downloading data from the URL collection source. The downloading client may also inquire the Tracker server and a peer simultaneously. After the downloading task is finished, the downloading client may report downloading time, downloading speed, a downloading result and file size of the downloading task, the source link. The downloading client may further report downloading speed and downloading time corresponding to each of the different URL sources. The downloading client may report such information to the statistics server. Additionally, once downloading of data fragments is completed, the downloading client may perform a check on the downloaded data fragments and report any errors to the statistics server.

The resource index server may receive hash value of a file that the downloading client is requesting to be downloaded. The hash value may use an URL of the file as an index. The resource index server may also receive the multi-URL resource collection of the file. Further, the resource index server may provide file fragment check information for the downloading client to check the validity of the downloaded data.

The Tracker server may register each client requesting to join the network. The Tracker server may also provide a list of addresses of nodes where a resource is disbursed. The Tracker server may further receive an online condition report of the client. Besides generating the node list corresponding to each resource, the Tracker server may also send the node list to the downloading client when the downloading client requests a download task for the resource. The Tracker server may also be responsible for receiving a peer online control policy for synchronization with a bandwidth scheduling server, and sending the peer online control policy to a peer client when the peer logs in.

The statistics server may receive a report for URL downloading speed, downloading time, connectivity, a downloading result and file size and so on about the client when the downloading is completed or is underway. The statistics server may record the information in a log file so as to perform statistical analysis at a later time. Alternatively, or in addition, the statistics server may analyze the information at the time of receipt of the information.

Referring to FIG. 1, in the P2SP network, the flow chart of the downloading of a network resource may include the following steps. The user may acquire an original URL of a network resource to be downloaded from the Internet or a resource website. The user may use the original URL as an entry and may query a resource index server for the multi-resource URL collection and HASH value of a file or files corresponding to the network resource. The downloading client may download data of the network resource from the inquired URL. The file information of the file(s) of the network resource may be registered into the Tracker server when the downloading complete Another client i.e. the other downloading client, may query the Tracker server for available P2P peers to download the file(s) corresponding to the network resource. Such peers may include peers that have completely downloaded the file(s) and/or peers where downloading of the file(s) is currently underway. The other downloading client may start inquiring the peers and requesting multi-source P2P download, so that data is exchanged among the peers. Statistical information may be reported to the statistics server when the downloading is completed.

In any one of the downloading technologies described above, posting and sharing download information of a network resource, i.e. a source download link address, for downloading by all the users, can be a challenge. The download information of the network resource may be shared and posted in several ways as follows.

The download information of the network resource may be directly posted on the downloading website or network forum, and a downloading user may acquire the source download link address of the network resource from the downloading website or network forum.

A receiving user may transfer and/or shares the source download link address for downloading the network resource through various instant communicating systems across a network.

The source download link address of the network resource may also be shared by using a microblog.

The above-mentioned way of sharing the download information of the network resource by using a microblog is popular.

The microblog, also referred to as a micro type blog, is a network platform for sharing, transferring and/or acquiring information based on user relationship. The user may access the microblog through a wired communication network or wireless communication network. Providers of a microblog platform, such as Twitter, may provide one or more clients to interact with the platform. The various clients, may be used to update information via a communication network. The update information may contain a designated number of characters (for example, 140 characters or so) and/or other multimedia information so as to share the information instantly. The microblog may bind media such as a mobile phone short message, a social website and a blog together. Such a binding may connect the various modes of social presence i.e. between the microblog and the various media so that information across such modes may be shared in wide range. The microblog may be a preferable way for information transferring by users owing to the speed and possibility of changing the track of information access. Users of such social media may sometimes be referred to as ‘netizens’. Thus, a mircoblog may allow users to access the website and obtain information. Moreover, the mircoblog may be a new tool for a portal website to attract and retain users.

Various microblogging platforms may be open to public access or use, and may be a mainstream of the Internet. A microblog platform may be an open platform for subscribing, sharing and communicating information via a microblog system or client. The existing user spread of the microblog systems may allow a fissioned-type spread by sharing large amount of information between users connected via the microblogging systems. The platform may provide a sharing button, a dynamic show plug-in, and/or any other technique to share information with other systems and websites. Such sharing features may allow a cooperation, or integration, with another system to add the microblog as a social feature to a website. The sharing features may enable such integration simply with several lines of HTML code. Moreover, the shared content may be shown on the microblog website, and further related content may be obtained directly when a user clicks a link embedded in the microblog. The contents which may be shared and downloaded in the microblog may increase, and several application programming interfaces (API) may be provided to help the cooperating system to realize more features. One such feature may be to enable users to share new network resources onto the microblog platform.

In view of the above-mentioned characteristics of the microblog, the microblog may be an important platform for sharing and transferring network resource download information.

However, sharing network resource download information via microblogs may have disadvantages, such as those listed below.

The various application programming interfaces (API) enable large number of users to easily update microblog information through a mobile phone, a network and so on. The information may be spread quickly. This may facilitate the downloading and transferring of a network resource having illegal content. However, sharing the network resource download information via the microblog does not control such risk of spreading the download information, cannot audit and/or trace the download information of the network resource, and further cannot control the sharing and transferring of illegal information.

### SUMMARY OF THE INVENTION

In view of the above, the main object of the present invention is to provide a control system and method for sharing network resource download information, thereby effectively controlling the risk of spreading the network resource download information.

Examples of technical solutions of the above technical problem may be as follows. A control system for sharing network resource download information, may include a microblog sharing interface server, configured to receive, from a client, an instruction for sharing a network resource, and acquire a unique identifier corresponding to the network resource. The unique identifier may be calculated based on the source download link address of the network resource. The microblog sharing interface server may generate a corresponding download link entry address that carries, or includes the unique identifier and points to a transfer server. The microblog sharing interface server may post the download link entry address to a microblog and store the unique identifier in a resource sharing database. The resource sharing database may be configured to store the unique identifier of the shared network resource, and set a download control condition corresponding to the network resource. The transfer server may respond to a click performed, at a download client, on the download link entry address in the microblog. The transfer server may inquire the download control condition corresponding to the network resource from the resource sharing database using the unique identifier in the clicked download link entry address. The transfer server may also determine whether to allow downloading the network resource based on the download control condition. If the downloading of the network resource is allowed, the transfer server may obtain the source download link address of the network resource by performing a reverse calculation on the unique identifier. The transfer server may also send the source download link address to the download client, where the download link entry address is clicked.

A method for controlling sharing a network resource download information, may include receiving an instruction for sharing a network resource and acquiring and storing a unique identifier calculated corresponding to the network resource. The unique identifier may be based on the source download link address of the network resource. The method may further involve generating a download link entry address corresponding to the network resource that includes the unique identifier. Further, the method may include posting the download link entry address into a microblog and setting a download control condition corresponding to the network resource. After the download link entry address in the microblog is clicked, the method may be continued by inquiring the download control condition corresponding to the network resource using the unique identifier in the clicked download link entry address, and determining whether to allow downloading the network resource based on whether the download control condition is satisfied. If the downloading of the network resource is allowed, a reverse calculation may be performed on the unique identifier to obtain the source download link address of the network resource and the source download link address may be sent to the download client, where the download link entry address is clicked.

The present disclosure describes various embodiments to post a download link entry address of a network resource to a microblog rather than posting a source download link address by which the network resource can be directly accessed. A download control authentication may be triggered in response to clicking the download link entry address at a download client. The network resource may be downloaded if the download control condition is satisfied. Thus, the embodiments may effectively control a risk of spreading of the network resource download information based on the control condition. Consequently, the embodiments may effectively control a risk of sharing and spreading of illegal information.

The above explanation only is an overview of the technical solutions described in the present disclosure. The specification describes few of the various possible embodiments according to the technical solution to make the above and other objects, features and advantages of the technical solution more easy to understand. Accordingly, particular embodiments will be illustrated in detail in conjunction with the drawings.

### BRIEF DESCRIPTION OF THE DRAWINGS

FIG. 1 is an example control flowchart of sharing and downloading a network resource using P2SP technology;

FIG. 2 is a schematic diagram of an example control system for sharing network resource download information; and

FIG. 3 is a schematic diagram of an example control system for sharing network resource download information applied in a P2SP configuration.

### DETAILED DESCRIPTION OF THE INVENTION

To further set forth the technology means and efficacy for the invention to achieve the above-mentioned invention purpose, in the following, particular embodiments, structures, features and efficacy of the sharing control system and method for network resource download information proposed according to the invention will be illustrated in detail in conjunction with the drawings and the preferable embodiments.

The above and other technical contents, features and efficacy of the invention will be clearly presented in the following detail illustration in conjunction with the preferable embodiments shown in the drawings. By the illustration of the particular embodiments, the efficacy and technology means of the invention which are adopted for the above-mentioned purpose may be more deeply and specifically understood. However, the drawings are only for reference and illustration, not for limiting the invention. It is to be understood that the following description of examples of implementations are given only for the purpose of illustration and are not to be taken in a limiting sense. The partitioning of examples in function blocks, modules or units shown in the drawings is not to be construed as indicating that these function blocks, modules or units are necessarily implemented as physically separate units. Functional blocks, modules or units shown or described may be implemented as separate units, circuits, chips, functions, modules, or circuit elements. Alternatively, or in addition, one or more functional blocks or units may also be implemented in a common circuit, chip, circuit element or unit.

FIG. 2 is a schematic diagram of an embodiment of a control system for sharing network resource download information. Referring to FIG. 2, the control system may include a microblog sharing interface server 201, a resource sharing database 202, and a transfer server 203.

The microblog sharing interface server 201 may be encapsulated within a microblog sharing interface that may be invoked by a client. The microblog sharing interface may be configured to receive an instruction for sharing a network resource from a sharing client 200. The microblog sharing interface may acquire a unique identifier calculated from a source download link address of the network resource. In one example, the microblog sharing interface server 201 may inform the sharing client 200 to calculate the unique identifier locally at the sharing client 200. In another example, the microblog sharing interface server 201 may acquire the unique identifier for the source download link address of the network resource from a resource provider. Here, for example, the sharing client 200 may be a browser of a computer, a browser of a mobile phone, a browser of a tablet computer, or any other client device/mechanism such as a microblog client or a download tool client.

The unique identifier for the source download link address of the network resource may be a file ID of the network resource, also called a HASH value, which may be referred to as key information in the download link. Files may be identified by the respective unique identifiers, such as HASH values. For example, even if files have different filenames, the download platform may identify and/or regard the files as the same file if the files have the same HASH value i.e. file ID.

After acquiring the unique identifier for the source download link address of the network resource, the microblog sharing interface server 201, may generate a corresponding download link entry address that carries the unique identifier and points to the transfer server 203. The microblog sharing interface server 201 may post the download link entry address into the microblog. The microblog sharing interface server 201 may further store the unique identifier for the network resource in a resource sharing database.

The download link entry address may have to be formatted to meet a post standard of the microblog. For example, the post standard may require the length of the download link entry address to be less than a maximum information length allowed in the microblog (such as 140 words, or 140 characters). By complying with the post standard, the success rate of posting the network resource download information by using the microblog may be greatly improved. Moreover, the specific sharing content and the resource description and the source download link address may be provided on a transfer page, thereby a limitation on word count, such as 140 words in the microblog, which may prevent a user to achieve sufficient expressiveness, may be resolved.

The resource sharing database 202 may store the information of the shared network resource. Such information may include the unique identifier for the network resource. The information may further include a description of the network resource. The resource sharing database 202 may also store a download control condition corresponding to the network resource.

The transfer server 203 may respond to a click performed on the download link entry address in the microblog. For example, the download link entry address may be browsed in the microblog by a user with a local browser of a downloading client 210. The user may click the download link entry address. The click may generate a request to download the network resource which may be diverted to the transfer server 203. The transfer server 203 may inquire the download control condition corresponding to the network resource from the resource sharing database 202 according to the unique identifier carried by the clicked download link entry address. The transfer server 203 may determine whether to allow downloading the network resource based on the download control condition. If downloading of the network resource is allowed, the transfer server 203 may perform a reverse calculation on the unique identifier to obtain the source download link address of the network resource and further, may send the source download link address to the downloading client 210 where the download link entry address is clicked.

There may be multiple ways to send the source download link address, of which two are described below. A person of ordinary skill in the art may identify the other possible ways based on the description. One example way to send the source download link address may be redirection, i.e., the transfer server 203 does not generate a transfer page, and may redirect the source download link address to the downloading client 210, i.e. the ‘click client’ where the initial user click was performed. The click client may, then, directly download the network resource by using a tool such as the browser. The click client also may invoke a download tool to directly download the network resource. In another example, the transfer server 203 may generate a transfer page, on which the source download link address is displayed. The transfer server 203 may, then, send the transfer page to the downloading client 210 where the download link entry address is clicked. The user may further click the source download link address on the transfer page and download the network resource by the browser or the download tool.

In another embodiment, the microblog sharing interface of the microblog sharing interface server 201 may receive the description information of the shared network resource from the sharing client 200. The description information may include the title, text description or picture description of the network resource. The description information of the network resource may be stored in the resource sharing database 202. The microblog sharing interface server 201 may bind the description information with the unique identifier of the network resource. If the description information related to the network resource is stored in the resource sharing database 202, the transfer server 203 may be configured to inquire the description information related to the network resource from the resource sharing database 202 according to the unique identifier included in the clicked download link entry address. The transfer server 203, may further generate the transfer page that includes the source download link address and the related description information. The transfer server 203 may then send the generated transfer page to the downloading client 210 where the download link entry address is clicked. The user may further click the source download link address on the transfer page and download the network resource by the browser or the corresponding download tool via the downloading client 210.

The present embodiments describe controlling sharing of network resource download information, and should not be considered as the only possible embodiments to solve the technical problem. Further, the description of the embodiments should not be considered as the only ways to download the network resource. The P2S, P2P, P2SP techniques and the like may be applied to download the network resource. The differences among these download techniques are described below. If the network resource is downloaded using P2S, the source download link address may generally be the direct download address of the network resource (such as a video file). If the network resource is downloaded via P2P or P2SP, the source download link address may generally be the direct download address of a peer file (such as a bit-torrent (BT) peer file or an emule peer file). After acquiring the address of the peer file, the downloading client 210 may acquire a corresponding URL address using a download tool associated with the peer file to download the network resource, such as a bit-torrent client for a bit-torrent file.

An embodiment which uses the P2SP download network is further described with reference to FIG. 3. FIG. 3 is a schematic diagram of the embodiment where the control system for sharing the network resource download information uses the P2SP download platform. Referring to FIG. 3, the P2SP network may include downloading clients 302 and 303, a resource index server, a Tracker server and a statistics server. A control system 300 may include the microblog sharing interface server 201, the resource sharing database 202 and the transfer server 203. A downloading client may be a sharing client 301. The downloading client 301 may invoke the interface of the microblog sharing interface server 201 to share the download information, and hence is referred to as the sharing client 301 herein. The sharing client 301 may be a browser that accesses a certain resource sharing website. The resource sharing website may invoke the interface of the microblog sharing interface server 201 to share the download information. The downloading client may acquire the download link entry address from the microblog platform 204, and download the corresponding network resource file by means of the source download link address URL sent from the transfer server 203. If the URL supports the redirection, the network resource may be downloaded from the redirected file.

Referring to FIG. 3, the control system for sharing the network resource download information according to the embodiment may seamlessly integrate P2SP download platform and the microblog platform 204 without affecting their respective features and advantages.

The embodiment of the control method for sharing the network resource download information, shown in FIG. 3 is further illustrated below.

The method to control sharing network resource download information according to an embodiment may include the following steps.

The sharing control system 300 may receive an instruction for sharing a network resource from the sharing client 301. The sharing control system 300 may obatain and store a unique identifier calculated from a source download link address of the network resource. The sharing control system 300 may further generate a download link entry address that includes the unique identifier and corresponds to the network resource. The sharing control system 300 may also post the download link entry address into the microblog and set the download control condition corresponding to the network resource.

Once the download link entry address in the microblog is clicked, at a downloading client 302, the sharing control system 300 may obtain the download control condition corresponding to the network resource based on the unique identifier carried by the clicked download link entry address. The sharing control system 300 may determine whether to allow downloading the network resource based on the download control condition. If the downloading of the network resource is allowed, the sharing control system 300 may perform a reverse calculation on the unique identifier to obtain the source download link address of the network resource and send the source download link address to the downloading client 302 where the download link entry address is clicked.

In the following, the detailed processes and more embodiments of the method will be described.

Referring to FIG. 3, the sharing client 301 may invoke the interface of the microblog sharing interface server 201 after or at the same time when the network resource is downloaded, so as to issue an instruction for sharing the network resource (such as a video file) to the microblog sharing interface server 201.

Upon receiving the instruction for sharing the network resource, the microblog sharing interface server 201 may obtain a unique identifier calculated from the source download link address of the network resource. The unique identifier may be a HASH value of the source download link address. The interface may command the sharing client 301 to search the source download link address of the network resource, based on which the HASH value may be calculated. The HASH value may be uploaded to the microblog sharing interface server 201. After obtaining the HASH value of the network resource, the microblog sharing interface server 201 may store the HASH value in the resource sharing database 202, and set a download control condition corresponding to the network resource in the resource sharing database 202. An application programming interface of the resource sharing database 202 may be used for this purpose. The microblog sharing interface server 201 may also generate the download link entry address that carries the HASH value corresponding to the network resource, and post the download link entry address onto the microblog platform 204. The microblog sharing interface may prompt the sharing client 301 to input the microblog account and password, and verify the microblog account and password. After the verification completes successfully, the microblog sharing interface may post the download link entry address into a microblog article and/or post corresponding to the microblog account.

The above steps or operations describe sharing of the network resource. The steps or operations performed for the download control process are described further.

After the download link entry address is posted onto the microblog platform 204, a user of the downloading client 302 may browse the corresponding microblog article by using a tool such as a browser and click or select the download link entry address. Since the download link entry address may point to the transfer server 203, after the download link entry address in the mircoblog is clicked, the transfer server 203 may obtain the HASH value carried by the download link entry address. The transfer server 203 may query the resource sharing database 202 for the download control condition corresponding to the network resource using the HASH value. The transfer server 203 may determine whether to allow downloading the network resource based on the download control condition. If the downloading of the network resource is allowed, the transfer server 203 may perform a reverse calculation using the HASH value to obtain the source download link address of the network resource and send the source download link address to the client 302 where the download link entry address is clicked.

Thus, the risk of spreading of the network resource download information may be effectively controlled. Various scenarios for setting the download control condition and/or controlling the download in other ways may be possible. In the following, four kinds thereof are introduced. Other specific download control conditions and control ways may be set by the administrator himself/herself. Such other possible ways would be obvious to a person skilled in the art based on the description provided in this document.

### First Download Control Embodiment

Setting the download control condition corresponding to the network resource may include setting effective time corresponding to the network resource. When the sharing client 301 shares the network resource, the microblog sharing interface may generate a timestamp and store the timestamp bound with the unique identifier for the shared network resource to be stored in the resource sharing database 202. After the download link entry address is clicked at the downloading client 302, the download control condition is used to determine whether to allow downloading the network resource. Such determination may include inquiring the timestamp and the effective time corresponding to the unique identifier for the network resource from the resource sharing database 202, and determining whether the current time exceeds the effective time corresponding to the network resource. If, for example, result of subtracting the timestamp from the current time is longer than the effective time corresponding to the network resource, the download may not be allowed; otherwise, the download is allowed. There may be other checks performed based on the effective time.

### Second Download Control Embodiment

In the P2SP platform such as shown in FIG. 3, the statistics server may be configured to receive a report including information such as URL downloading speed, downloading time, connected situation, a downloading result and file size from the downloading client 302 when the downloading is completed or is underway. The statistics server may write a log file for subsequent statistics analysis, for example, to count number of times a network resource is downloaded.

In this embodiment, setting of the download control condition corresponding to the network resource may include setting a maximum number of times the network resource may be downloaded. In this case, after the download link entry address is clicked, determining whether to allow downloading the network resource based on the download control condition may include the following steps. The transfer server 203 may acquire, from the statistics server, the number of times the network resource has been downloaded. The transfer server 203 may also query the resource sharing database 202 based on the unique identifier for the maximum number of times the network resource may be downloaded. The transfer server 203, may then determine whether the number of times the network resource has been downloaded is larger than the allowed maximum number of times. If the number of times the network resource has been downloaded is larger than the allowed maximum, the download may not allowed; otherwise, the download may be allowed.

### Third Download Control Embodiment

In this embodiment, the download control condition corresponding to the network resource may involve obtaining a microblog account of a network resource sharer by using microblog sharing interface, and binding the microblog account with the unique identifier for the network resource. The binding may be stored in the resource sharing database 202. A relation chain condition between a microblog account that is allowed to download the network resource and the microblog account of the sharer may be created. For example, the relation chain condition may be that the microblog account of the user requesting download must be a “follower” of the microblog account of the sharer. A “follower” in the microblog context may be a user that may instantly see what the “being followed user” (i.e. the sharer) may post as or in a microblog.

Once the download link entry address is clicked, determining whether to allow download of the network resource based on the download control condition, in this case, includes obtaining the microblog account of the user who clicks the download link entry address. Further a relation chain information from the microblog platform 204 may be obtained by the microblog sharing interface server 201. Whether the microblog account of the downloading user and the microblog account of the sharer meet the relation chain condition set as the download control condition is then determined based on such information. If the relation chain condition set as the download control condition is met, the download is allowed; otherwise, the download is not allowed. Other relation chains between the sharer and a downloader may be used as download conditions.

### Fourth Download Control Embodiment

When the sharing client 301 shares the network resource, the microblog sharing interface may need to further calculate an authentication check code of the shared network resource. The download link entry address posted, may further include the authentication check code in the microblog, and further the authentication check code may be stored in the download control condition corresponding to the network resource.

Once the download link entry address in the microblog is clicked at the downloading client 302, determining of whether to allow downloading the network resource based on the download control condition, in this case, may include obtaining the authentication check code in the clicked download link entry address. The authentication check code in the clicked download link entry address may be compared with the authentication check code corresponding to the unique identifier for the network resource which may be obtained from the resource sharing database 202. If the two authentication check codes are consistent, the download is allowed; otherwise, the download is not allowed.

There may be at least two ways for the transfer server 203 to send the source download link address. One way is redirection, that is, the transfer server 203 without generation of a transfer page, sends the redirected source download link address to the downloading client 302. The downloading client 302 may, then, download the network resource by using tools such as a browser, or a special download client to directly download the network resource. For instance, in the embodiment shown in FIG. 3, the special P2SP client may be invoked for downloading. Another way may be that the transfer server 203 may generate a transfer page, on which the source download link address is displayed. The transfer server 203 may send the generated transfer page to the client 302 where the download link entry address is clicked. The user may further click the source download link address on the generated transfer page and download the network resource by the browser or the corresponding P2SP client.

In an embodiment, the interface of the microblog sharing interface server 201 may be further configured to receive the description information related to the shared network resource from the sharing client 301 (such as the title, text description or picture description of the network resource). The description information may be stored in the resource sharing database 202. The microblog sharing interface server 201 may bind the description information with the unique identifier for the network resource. If the description information related to the network resource is stored in the resource sharing database 202, the transfer server 203 may query the resource sharing database 202 based on the unique identifier for the description information related to the network resource. The transfer server 203 may further generate a transfer page that includes the source download link address and the related description information, and send the generated transfer page to the downloading client 302 where the download link entry address is clicked. The user may further click the source download link address on the generated transfer page and download the network resource by the browser or the corresponding P2SP client.

In the case of an embodiment, referring to in FIG. 3, the downloading client 302 may query a resource index server by using the P2SP client with the acquired source download link address as a entry, to obtain multi-resource URL collection and HASH value of the network resource. The downloading client 302 may then download from the URL collection source (the path may include a file server on the Internet, a resource website and/or other peer client). The downloading client 302 may further register information of the network resource into the Tracker server. Other downloading clients, such as the downloading client 303 may inquire for P2P peers from which at least a part of the network resource may be downloaded. A P2P peer may be a peer that has completed downloading the network resource and/or a peer where downloading the network resource is underway. Such queries may be made to the Tracker server. The downloading client 303 may begin to inquire the Tracker server for multisource P2P peers, and exchange the download data among the obtained peers, thus achieving a sharing download in P2SP.

In an embodiment using the P2SP platform as illustrated in FIG. 3, the statistics server may record downloading behavior of the user, for example, by receiving a report of information such as URL downloading speed, downloading time, connected situation, a downloading result and file size from the downloading client 302 when the downloading is completed or is underway. The statistics server may write a log file for subsequent statistics analysis. The statistics server may also synchronize the information such as a title of a related file to which the microblog downloaded by the user links to. The synchronized information may also contain P2SP account of the downloading client. The statistics server may synchronize the information with the resource sharing database 202. Thus, in another embodiment, the resource sharing database 202 may communicate with the statistics server, obtain the downloading behavior record of the user who clicks the download link entry address (the P2SP account of the downloading client 302) from the statistics server. The transfer server 203 may further obtain the P2SP account from the downloading client 302 before generating a transfer page. The transfer server 203 may inquires the downloading behavior record of the account from the resource sharing database 202 based on the account, and generate a recommended content for the user based on the downloading behavior record. The transfer server 203 may then generate a transfer page and send the transfer page to the downloading client 302. The transfer page may include the source download link address and the related description information of the network resource and the recommended content. Generating the recommended content for the user based on the downloading behavior record of the user, for example, may include analyzing a resource category which is most often downloaded by a user in the downloading behavior record. For example, a certain user may download resources of a movie category more frequently. Download information of network resources in the same category may be obtained from a certain resource database (such as a cooperative resource website) based on the resource category. In the above example, the download information of network resources of the movie category may be used as the recommended content. Transformation efficiency of content on the transfer page may be improved based on the content recommending mechanism.

The above embodiments describe system and method to post, in a microblog, the download link entry address rather than the source download link address by which the network resource can be directly accessed. Description is also provided of embodiments in which the download control authentication may be triggered by clicking the download link entry address. The network resource may be downloaded only if the download control condition is met. Thus, the embodiments may effectively control the risk of spreading of the network resource download information according to the requirements of the control condition, and especially, may effectively control the risk of sharing and spreading of illegal information.

Furthermore, the original object of the microblog is a micro type blog, so the length of the posted content may be strictly limited. For example, the length of each microblog may be limited to 140 words, or equivalent to the capacity of two short messages. The length limit may be decided by the mobile communication standards, according to the international standards. Each short message may send content containing 1120 bits, i.e. 140 bytes, at most. Thus the microblog system may set said upper limit. However, the number of words of the source download link of many network resources is larger than 140 bytes, and generally the download information may also contain some description information of the network resource. If the download information is shared by the microblog, those source download link contents with length larger than the length limited by the microblog may not be shared successfully since the microblog limits the length of the posted content. Thereby, the success rate for posting the network resource download information by using the microblog may be lower. Moreover, due to the word limit in the microblog, the microblog may not achieve sufficient expressiveness as for the network resource. However, as described, the download link entry address may meet the posting standards of the microblog, that is, the length of the download link entry address may be less than the maximum information posting length allowed in the microblog. In this way, the success rate for posting the network resource download information by using the microblog may be greatly improved. Moreover, the specific information about the shared network resource content, the resource description and the source download link address may be provided on a transfer page, to overcome that the limit of 140 words on the microblog which may lead to insufficient expressiveness.

Various embodiments described herein can be used alone or in combination with one another. The foregoing detailed description has described only a few of the many possible implementations of the present disclosure. For this reason, this description of example embodiments is intended by way of illustration, and not by way of limitation. Some modifications and equivalents can be made to the technical solution of the present invention by those skilled in the art in light of the technical content disclosed above without deviation from the scope of the present disclosure. Therefore, any simple change, equivalent alternation and modification made to the above embodiments according to the technical principle of the present disclosure without deviation from the scope of the present disclosure all fall within the scope of protection of the technical solution of the present disclosure.

### INDUSTRIAL APPLICABILITY

Above embodiments describe ways by which, the download link entry address rather than the source download link address by which the network resource can be directly accessed is posted in the microblog. The download control authentication may be triggered by clicking the download link entry address. The network resource may be downloaded only if the download control condition is met. Thus, the present invention can effectively control the risk of spreading of the network resource download information according to the control requirement, and, can effectively control the risk of sharing and spreading of illegal information.

What is claimed is:

1. A control system for sharing network resource download information, comprising:
a microblog sharing interface server, configured to receive an instruction from a client to share a network resource;
the microblog sharing interface server further configured to obtain a unique identifier of the network resource, wherein the unique identifier is based on a source download link address of the network resource;
the microblog sharing interface server further configured to generate a download link entry address that includes the unique identifier and points to a transfer server;
the microblog sharing interface server further configured to post the download link entry address into a microblog;
the microblog sharing interface server further configured to store the unique identifier for the network resource in a resource sharing database;
the resource sharing database configured to store the unique identifier of the shared network resource, and set a download control condition corresponding to the network resource; and
the transfer server configured to respond to a click performed on the download link entry address in the microblog, the click performed at a download client;
the transfer server configured to inquire the download control condition corresponding to the network resource from the resource sharing database according to the unique identifier included in the clicked download link entry address;
the transfer server configured to determine whether to allow downloading the network resource based on the download control condition, and if the download of the network resource is allowed, obtain the source download link address of the network resource based on the unique identifier; and
the transfer server configured to send the source download link address to the download client, if the downloading of the network resource is allowed.

2. The system according to claim 1, wherein the transfer server is further configured to generate a transfer page, on which the source download link address is displayed, and send the transfer page to the download client.

3. The system according to claim 2, wherein,
the microblog sharing interface server is further configured to receive description information related to the network resource from the client, and store the description information related to the network resource in the resource sharing database;
the transfer server is further configured to inquire the description information related to the network resource from the resource sharing database based on the unique identifier included in the clicked download link entry address;
the transfer server is further configured to generate the transfer page that comprises the source download link address and the related description information; and
the transfer server is further configured to send the transfer page to the download client.

4. A method for controlling sharing of network resource download information, comprising:
receiving an instruction for sharing a network resource;
obtaining and storing a unique identifier calculated based on a source download link address of the network resource;
generating a download link entry address corresponding to the network resource, the download link entry address includes the unique identifier;
posting the download link entry address to a microblog;
setting a download control condition corresponding to the network resource; and
determining that the download link entry address in the microblog is clicked at a download client;
inquiring the download control condition corresponding to the network resource based on the unique identifier in the clicked download link entry address;
determining whether to allow downloading the network resource based on the download control condition;
performing a reverse calculation on the unique identifier to obtain the source download link address of the network resource; and
sending the source download link address to the download client.

5. The method according to claim 4, wherein after the source download link address of the network resource is obtained by performing the reverse calculation on the unique identifier for the network source,
generating a transfer page comprising the source download link address; and
sending the transfer page towards the download client.

6. The method according to claim 5, wherein after the instruction for sharing the network resource is received, the method further comprises:
obtaining and storing description information related to the network resource; and
adding the description information related to the network resource to the transfer page.

7. The method according to claim 5, wherein the method further comprises:
obtaining, from a statistics server, a downloading behavior record of a user of the download client;
generating a recommended content for the user based on the downloading behavior record; and
adding the recommended content to the transfer page.

8. The method according to claim 4, wherein the setting the download control condition corresponding to the network resource comprises:
setting effective time corresponding to the network resource; and
the determining whether to allow downloading the network resource based on the download control condition further comprises:
determining whether current time exceeds the effective time corresponding to the network resource, and allowing the download if the current time exceeds the effective time corresponding to the network resource, and disallowing the download if the effective time does not exceed the effective time corresponding to the network resource.

9. The method according to claim 4, wherein the setting the download control condition corresponding to the network resource comprises:
setting a maximum number of times the network resource can be downloaded; and
the determining whether to allow downloading the network resource based on the download control condition further comprises:
obtaining, from a statistics server, the number of times the network resource has been downloaded;
determining whether the number of times is larger than the maximum number of times, and disallowing the download if the number of times is larger than the maximum number of times, and allowing the download if the maximum number of times is larger than the number of times.

10. The method according to claim 4, wherein the setting the download control condition corresponding to the network resource comprises:
obtaining and storing a microblog account of a network resource sharer;
setting a relation chain condition between a microblog account that is allowed to download the network resource and the microblog account of the sharer; and
the determining whether to allow downloading the network resource based on the download control condition further comprises:
obtaining the microblog account of a user of the download client;
obtaining, from a microblog system, a relation chain information of the microblog account of the user;
determining whether the microblog account of the user and the microblog account of the sharer meet the relation chain condition set as the download control condition, and allowing the download if the download control condition is satisfied, and disallowing the download if the download control condition is not satisfied.

11. The method according to claim 4, wherein the method further comprises:
calculating authentication check code of the network resource wherein the authentication check code is embedded in the download link entry address posted on the microblog;
storing the authentication check code in the download control condition;
the determining whether to allow downloading the network resource based on the download control condition further comprises:
obtaining the authentication check code in the clicked download link entry address;
comparing the authentication check code in the clicked download link entry address with the authentication check code of the network resource stored in the download control condition, and allowing the download if the authentication check code in the clicked download link entry address is consistent with the authentication check code of the network resource stored in the download control condition and disallowing the download if the two authentication check codes fail to match.

12. The method according to claim 4, wherein the length of the download link entry address is less than the maximum information posting length allowed in the microblog.
